(19) United States
(12) Patent Application Publication
(10) Pub. No.: US 2026/0283217 A1
(43) Pub. Date: Sep. 24, 2026

(54) Extruded Puffed High Insoluble Fiber Food and High Total Fiber Pieces and Methods of Making

(71) Applicant: General Mills, Inc., Minneapolis, MN (US)

(72) Inventors: Jose Daniel Estrada Andino, Roseville, MN (US); Obediah Cooper, Coon Rapids, MN (US); Douglas L. Goedeken, Blaine, MN (US); Eric T. Gugger, Plymouth, MN (US); Jeffrey Thomas Huber, Robbinsdale, MN (US); Ravindranath Sreedhar Menon, Rogers, MN (US); Scott K. Whitman, New Hope, MN (US)

(73) Assignee: General Mills, Inc., Minneapolis, MN (US)

(21) Appl. No.: 19/472,227

(22) PCT Filed: Apr. 3, 2024
(86) PCT No.: PCT/US2024/022828

§ 371 Date: Oct. 3, 2025

Related U.S. Application Data
(60) Provisional application No. 63/456,625, filed on Apr. 3, 2023.

(51) Int. Cl. A23P 30/34; A23L 7/10; A23L 7/17

(52) U.S. Cl. CPC A23P 30/34; A23L 7/115; A23L 7/17

(57) ABSTRACT

The present disclosure relates to low density, high fiber-containing ready-to-eat food pieces, compositions including such food pieces, and methods of making such food pieces. The food pieces include at least 35% and up to 50% by dry weight total fiber, an insoluble fiber content of at least 25% to about 40% by dry weight, and a soluble fiber content of about 5% to about 15% by dry weight. The food pieces consist essentially of bran, optionally a second insoluble fiber source, psyllium husk, and a starch ingredient, with a moisture content of up to 4% by weight. Compositions containing such high fiber food pieces and methods of making them are also described.

### TECHNOLOGY

The present disclosure generally relates to an extruded high fiber product with high insoluble fiber content, and methods of making such a product.

### BACKGROUND

High dietary fiber-containing foods can help consumers balance their nutritional needs. In addition, fiber can help improve satiety while contributing fewer calories than protein, digestible carbohydrates, and fats. Consumers want diverse ways to get increased fiber into their diets. Thus, there is a need for new high fiber food products to satisfy the increasing consumer desire for convenient and enjoyable eating experiences that contribute fiber.

### SUMMARY

Low density, high total fiber and high insoluble fiber, ready-to-eat food pieces that contain a total fiber content of least 32% by weight and an insoluble fiber content of at least 25% by weight, and methods of making such food pieces are provided herein.

A low density, high fiber, ready-to-eat (RTE) food piece is provided herein.

A ready-to-eat (RTE) puffed food piece can have a bulk density of 100 to 200 g per 100 in³, or about 120 to about 180 g per 100 in³, a total fiber content of at least 32% to about 50% by dry weight of the puffed food piece, an insoluble fiber content of at least 25% to about 40% by dry weight of the puffed food piece, and a soluble fiber content of about 5% to about 15% by dry weight of the puffed food piece, where the insoluble fiber content and the soluble fiber content are at a ratio of at least 2:1.

In some embodiments, a puffed food piece consists essentially of an amount of bran sufficient to provide insoluble fiber in an amount of at least 20% by dry weight of the puffed food piece; psyllium husk in an amount of about 5% to about 15% by dry weight of the puffed food piece; a starch ingredient having a starch content of at least 50% by dry weight of the starch ingredient, wherein the starch ingredient, the psyllium husk, and the bran contribute a total starch content in an amount of about 30% to about 65% by dry weight of the puffed food piece; and a moisture content of up to 4% by weight of the puffed food piece.

In some embodiments, a puffed food piece consists essentially of an amount of bran sufficient to provide insoluble fiber in an amount of at least 8% by dry weight of the puffed food piece; an amount of a second insoluble fiber source sufficient to provide an amount of insoluble fiber in an amount of at least 8% by dry weight of the puffed food piece, where the bran and the second insoluble fiber source provide a total insoluble fiber content of at least 20% by dry weight of the puffed food piece, the second insoluble fiber source having an insoluble fiber content of at least 75% by weight and selected from oat hull fiber, sugar cane fiber, rice fiber, bamboo fiber, refined cellulose, or a combination thereof; psyllium husk in an amount of about 5% to about 15% by dry weight of the puffed food piece; a starch ingredient having a starch content of at least 50% by dry weight of the starch ingredient, wherein the starch ingredient, the psyllium husk, the bran, and the second insoluble fiber source contribute a total starch content in an amount of about 30% to about 65% by dry weight of the puffed food piece; and a moisture content of up to 4% by weight of the puffed food piece.

In some embodiments, the total fiber content in a puffed food piece can be from about 38% to about 45% by dry weight of the puffed food piece.

In some embodiments, the insoluble fiber content can be from about 25% to about 35% by dry weight of the puffed food piece. In some embodiments, the insoluble fiber content and the soluble fiber content can be at a ratio of at least 3:1.

In some embodiments, the bran can be included in an amount sufficient to provide at least 90% by dry weight of the insoluble fiber content.

In some embodiments, where a second insoluble fiber source is included, the bran plus the second insoluble fiber source can provide at least 90% by dry weight of the total insoluble fiber content. In some embodiments, the ratio of insoluble fiber from the bran and insoluble fiber from the second insoluble fiber source can be from about 2:1 to about 1:2. In some embodiments, the second insoluble fiber source can be selected from oat hull fiber, sugar cane fiber, rice fiber, or a combination thereof.

In some embodiments, the psyllium husk can be included in an amount sufficient to provide at least 90% by dry weight of the soluble fiber content.

In some embodiments, the bran can include corn bran or wheat bran. In some embodiments, the bran can include corn bran and wheat bran at a ratio of 1:1 to 1:3 corn bran to wheat bran.

In some embodiments, the starch ingredient can include a grain flour or meal that contributes at least 50% by dry weight of the total starch content.

In some embodiments, other ingredients can total less than 5% by dry weight of the puffed food piece.

In some embodiments, a puffed food piece can have a bulk density of about 120 to about 180 g per 100 in³, a total fiber content of at least 38% to about 45% by dry weight of the puffed food piece, an insoluble fiber content of at least 25% to about 35% by dry weight of the puffed food piece, and a soluble fiber content of about 7% to about 10% by dry weight of the puffed food piece, where the insoluble fiber content and the soluble fiber content being are at a ratio of at least 3:1, the puffed food piece consisting of bran in an amount sufficient to provide at least 90% by dry weight of the insoluble fiber content; psyllium husk in an amount sufficient to provide at least 90% by dry weight of the soluble fiber content; a starch ingredient comprising a grain flour or meal that contributes at least 50% by dry weight of the total starch content; and other ingredients in an amount that totals less than 5% by dry weight of the puffed food piece.

A RTE food product is also provided. A RTE food product can include any puffed food piece described herein and a coating on at least a portion of a surface of the puffed food piece. A RTE food product can include an agglomeration that includes a binder and a plurality of any of the puffed food pieces described herein, where the binder binds the plurality together to form the agglomeration. A RTE food product can include an agglomeration that includes a binder, any puffed food piece described herein, and a second edible piece, where the binder binds the puffed food piece and the second edible piece together to form the agglomeration.

Also provided are methods of making a RTE puffed food piece. A method of making a RTE puffed food piece, can include providing a dry mix having a total fiber content of at least 35% to about 50% by dry weight of the dry mix, an insoluble fiber content of at least 25% to about 40% by dry weight of the dry mix, and a soluble fiber content of about 5% to about 15% by dry weight of the dry mix, the insoluble fiber content and the soluble fiber content being at a ratio of at least 2:1; under extrusion conditions, combining the dry mix with water to form a dough having a moisture content of about 8% to about 15% by weight of the dough; extruding the dough through a die opening and directly expanding the dough to form the RTE puffed food piece; and drying the RTE puffed food piece to a moisture content of 4% or less.

In some embodiments of a method of making a RTE puffed food piece, the dry mix can consist essentially of an amount of bran sufficient to provide insoluble fiber in an amount of at least 20% by dry weight of the dry mix; psyllium husk in an amount of about 5% to 15% by dry weight of the dry mix; and a starch ingredient having a starch content of at least 50% by dry weight of the starch ingredient, wherein the starch ingredient, the psyllium husk, and the bran contribute a total starch content in an amount of about 30% to about 65% by dry weight of the dry mix.

In some embodiments of a method of making a RTE puffed food piece, the dry mix can consist essentially of an amount of bran sufficient to provide insoluble fiber in an amount of at least 8% by dry weight of the dry mix; an amount of a second insoluble fiber source sufficient to provide an amount of insoluble fiber in an amount of at least 8% by dry weight of the dry mix, where the bran and the second insoluble fiber source provide a total insoluble fiber content of at least 20% by dry weight of the dry mix, the second insoluble fiber source having an insoluble fiber content of at least 75% by weight and selected from oat hull fiber, sugar cane fiber, rice fiber, bamboo fiber, refined cellulose, or a combination thereof; psyllium husk in an amount of about 5% to 15% by dry weight of the dry mix; and a starch ingredient having a starch content of at least 50% by dry weight of the starch ingredient, wherein the starch ingredient, the psyllium husk, and the bran contribute a total starch content in an amount of about 30% to about 65% by dry weight of the dry mix.

These and various other features and advantages will be apparent from a reading of the following detailed description.

### DETAILED DESCRIPTION

Consumers continually expect an even greater variety of convenient foods that deliver fiber and an enjoyable eating experience and are suitable for different eating occasions. However, insoluble fiber ingredients often contributed to taste, astringency, and textural problems, and have proven difficult to puff when included at high levels to produce a product that resembles a traditional ready-to-eat (RTE) grain-based breakfast cereal. The present application describes the discovery of high fiber compositions containing a total fiber content of least 32% (e.g., 35% to about 50%, or about 38% to about 45%) by dry weight, an insoluble fiber content of at least 25% (e.g., 25% to about 40%, or 25% to about 35%) by dry weight, and a soluble fiber content of about 5% to about 15% (e.g., about 6% to about 10%, or about 7% to about 9%) by dry weight that can be puffed into a low-density, high fiber RTE food piece having a pleasant, crunchy texture resembling traditional grain-based RTE breakfast cereal, and having a pleasant or neutral flavor, even in the absence of flavorants or off-flavor maskers.

The term “low density” refers to a food piece that has a bulk density of about 100 to about 200 (e.g., about 120 to about 180) g/100 cubic inches as a result of direct expansion following extrusion from an extruder die. A low density food piece may also be referred to as “puffed.” As used herein, the term “ready-to-eat” (“RTE”) refers to a food that does not require further cooking or preparation to be suitable and safe for consumption. A food piece provided herein is typically also shelf stable at room temperature for at least 3 months (e.g., at least 6 months, or 8 months to 1 year) without significant negative impact on texture, structure, or flavor when stored in appropriate packaging. A food piece provided herein can also be suitably coated, or it can be used in other products, such as dry snacks, snack blends, cold-formed or baked snack bars or clusters. A food piece provided herein can be agglomerated with similar food pieces and/or a second edible piece (e.g., rolled grain, nuts, fruit pieces, seeds, and the like) using a binder to produce agglomerations, such as clusters and granola-type bars. It is to be understood that the features of a food piece are described to include only the food piece, not any coatings, binders, or other pieces.

A food piece provided herein can consist essentially of an amount of bran sufficient to provide insoluble fiber in an amount at least 20% by dry weight of the food piece, psyllium husk in an amount of about 5% to about 15% by dry weight of the food piece, a starch ingredient, where the total starch content from the bran, psyllium husk, and starch ingredient is from about 25% to about 65% by dry weight of the food piece, and a moisture content of up to 4% by weight. Alternatively, a food piece provided herein can consist essentially of an amount of bran sufficient to provide insoluble fiber in an amount at least 8% by dry weight of the food piece, a second insoluble fiber source (e.g., oat hull fiber, sugar cane fiber, rice fiber, bamboo fiber, refined cellulose, or a combination thereof) sufficient to provide insoluble fiber in an amount of at least 8% by dry weight of the food piece, psyllium husk in an amount of about 5% to about 15% by dry weight of the food piece, a starch ingredient, where the total starch content from the bran, the second insoluble fiber source, psyllium husk, and starch ingredient is from about 25% to about 65% by dry weight of the food piece, where the total insoluble fiber content from the bran and the second insoluble fiber source is at least 20% by dry weight of the food piece, and a moisture content of up to 4% by weight. It was discovered that the herein described combination and amounts of bran, optional second insoluble fiber source, psyllium, and starch ingredient balanced density and texture with a high insoluble fiber content without requiring significant amounts of other ingredients, such as sugars or proteins, to achieve an enjoyable eating experience.

In some embodiments, the described compositions can deliver significant amounts of insoluble fiber while also limiting the amount of fermentable fiber included in the compositions. Fermentable fibers are generally fermented in the colon by gut bacteria into fermentation by-products, such as short-chain fatty acids and gases. While most soluble fibers (e.g., inulin, beta-glucan, guar gum) are fermentable fibers, most insoluble fibers and psyllium are not fermentable fibers. In some embodiments, the described compositions can contain essentially no (e.g., less than 2% by dry weight, less than 1% by dry weight, or 0% by dry weight) fermentable fiber. Thus, the described compositions can be consumed with reduced risk of gastrointestinal discomfort associated with fermentable fiber consumption.

As used herein, a food piece consisting essentially of bran, optional second insoluble fiber source, psyllium husk, a starch ingredient, and moisture, contains less than a total of 10% (e.g., less than 8%, less than 5%, or about 1% to about 4%) by dry weight any other ingredient, such as sugars, flavorants, colorants, processing aids, and the like. Typically, other ingredients are individually included in amounts of less than 8% (e.g., less than 3%) each.

A particular challenge in making a high fiber puffed food piece is in including significant amounts of insoluble fiber and still achieving a density and texture similar to traditional puffed RTE products, such as breakfast cereal. Although commercially available high fiber breakfast cereal products exist with insoluble fiber contents ranging from 27% to 43% by weight, they are much denser than a food piece provided herein, and typically come in forms such as flakes or “twigs.” Commercially available high fiber product densities are above 300 g per 100 cubic inches, and range up to 540 g per 100 cubic inches. In contrast, it was discovered that the herein described balance of bran, optional second insoluble fiber source, psyllium, and starch ingredient provided for a puffed food piece that has a density of about 100 to about 200 (e.g., about 120 to about 180) g per 100 cubic inches while still delivering an insoluble fiber content of at least 20% by dry weight of the food piece from bran or a combination of bran and second insoluble fiber source. It should be understood that insoluble fiber content in a food piece provided herein is contributed mostly by bran and optional second insoluble fiber source, but can include some insoluble fiber found in other ingredients, such as a starch ingredient. In some preferred embodiments, at least 90% (e.g., at least 92%, or at least 95%) of the insoluble fiber content in a food piece comes from bran. In some other preferred embodiments, at least 90% (e.g., at least 92%, or at least 95%) of the insoluble fiber content in a food piece comes from bran and a second insoluble fiber source selected from oat hull fiber, sugar cane fiber, rice fiber, bamboo fiber, refined cellulose, or combinations thereof.

As used herein the term “bran” refers to the combined aleurone and pericarp of a cereal grain (e.g., corn, wheat, rice, barley, rye, oat, and the like). Insoluble fiber content of a bran suitable for use herein can range from about 40% to about 85% by dry weight. In some embodiments, bran in a food piece can have an average insoluble fiber content of greater than 50% by dry weight of the bran. In some embodiments, bran in a food piece can include bran from a combination of sources. For example, in some embodiments, a bran with an insoluble fiber content of 50% or less by weight (e.g., wheat bran, oat bran, rice bran) and a bran with an insoluble fiber content of greater than 50% (e.g., corn bran, rye bran, barley bran), can be combined at a ratio suitable to achieve an average insoluble fiber content of greater than 50%. For example, corn bran and wheat bran can suitably be used at a ratio of about 1:1 to about 1:3 (e.g., about 1:2). Other components of a bran can include, for example, starch, soluble fiber, protein, and fat.

As used herein, a second insoluble fiber source is an insoluble fiber source having an insoluble fiber content of at least 75% (e.g., about 78% to about 98%) by dry weight. Suitable second insoluble fiber sources include, for example, oat hull fiber, sugar cane fiber, rice fiber, bamboo fiber, refined cellulose, and combinations thereof. If included, a second insoluble fiber source is included in an amount sufficient to provide an insoluble fiber content in a food piece that is at least 8% (e.g., about 9% to about 18%, or about 10% to about 15%) by dry weight of the food piece, and the combined bran and second insoluble fiber source provide a total insoluble fiber content of at least 20% by dry weight of the food piece. In some embodiments, where a second insoluble fiber source is included, the amount of insoluble fiber from the insoluble fiber and the amount of insoluble fiber from bran can be at a ratio of about 1:2 to about 2:1 (e.g., about 1:1).

Psyllium husk is included in a food piece provided herein in an amount of about 5% to about 15% (e.g., about 8% to about 15%, or about 10% to about 15%) by dry weight of the food piece. Although previous attempts at making a high fiber puff, such as disclosed in EP0144644, included psyllium husk, those attempts included psyllium husk as the source of most of the fiber and was included in a very broad range (e.g., 10-80% by weight). However, the present inventors discovered that formulations that include too much psyllium husk (i.e., exceeding about 15%) puffed upon extrusion, but limited the amount of insoluble fiber that could be included. In contrast, too little psyllium husk results in poor puffing, and a density that is greater than 200 g per 100 cubic inches. Inclusion of psyllium husk in an amount of about 5% to about 15% by dry weight supports a high insoluble fiber content of at least 25% by dry weight in a puffed food piece with a stable structure and texture. In contrast to the presently disclosed food pieces, the compositions in EP0144644 failed to achieve even 20% by weight bran, which is insufficient to deliver at least 20% insoluble fiber as provided in the herein described compositions. EP0144644 also failed to include more than 1.5% by weight of an insoluble fiber source that has an insoluble fiber content of at least 75%, which is insufficient to deliver at least 8% insoluble fiber as provided in the herein described compositions that contain a second insoluble fiber source.

A ratio of insoluble fiber content to soluble fiber content of at least 2:1 (e.g., at least 2.5:1, at least 3:1, about 3:1 to about 4:1, or about 3.2:1 to about 3.8:1) can maximize the amount of insoluble fiber content while achieving the desired density and texture. It should be understood that soluble fiber content in a food piece provided herein is contributed mostly by psyllium husk, but can include some soluble fiber found in other ingredients, such as a starch ingredient or bran. In some preferred embodiments, at least 90% (e.g., at least 92%, or at least 95%) of the soluble fiber content in a food piece comes from psyllium husk.

Although a psyllium content of about 5% to about 15% could support puffing when combined with bran, it was discovered that an amount of starch was necessary to enable sustainable production since amounts of insoluble fiber exceeding 50% by dry weight resulted in high density and an unacceptable appearance, while amounts of psyllium husk exceeding 15% resulted in puffing followed by collapse. A starch ingredient is included in a food piece provided herein. Suitable starch ingredients include, for example, a flour, a meal, a purified starch (e.g., native, modified, pregelatinized, or any combination), or a combination thereof. Preferably, a starch ingredient comprises a grain flour or meal, such as corn flour or corn meal.

The starch ingredient, the psyllium husk, and the bran contribute to a total starch content in a food piece of from about 30% to about 65% (e.g., about 32% to about 50%, or about 34% to about 40%) by dry weight of the food piece. In some preferred embodiments, at least 50% (e.g., at least 55%, or at least 60%) of the total starch content in a food piece comes from a grain flour or meal.

A food piece described herein can suitably be used in applications similar to a traditional puffed food piece, such as a RTE breakfast cereal piece. For example, a food piece can have a coating, e.g., a carbohydrate-based, sugar alcohol-based, or fat-based coating, added to part or all of a surface to modify taste, appearance, texture, or the like. In some cases, a coating can contribute other attributes, such as increased bowl life for a RTE cereal. In some embodiments, a coating can be added at a rate of up to about 40% (e.g., about 10% to about 35%) by weight of the combined food piece and coating. It is to be understood that the description above with respect to ingredient content of a food piece does not take into account a coating.

A method provided herein includes processing a composition including a dry mix and water under extrusion conditions to produce a food piece. As used herein, the term “extrusion conditions” refers to subjecting a composition to heat, pressure, and shear in an extruder (e.g., single screw extruder, twin screw extruder, triple screw extruder, ring extruder, or the like). For example, a co-rotating, intermeshing, twin screw extruder can be used in a method provided herein. Manufacturers for co-rotating twin screw extruders include, for example, Coperion, Wenger, Clextral, Berstorff, APV, Baker Perkins, Buhler, and Leistritz.

A dry mix suitable for extrusion in a method provided herein includes a total fiber content of at least 35% to about 50% by dry weight of the dry mix, an insoluble fiber content of at least 25% to about 40% by dry weight of the dry mix, and a soluble fiber content of about 5% to about 15% by dry weight of the dry mix. A dry mix includes bran, psyllium husk, and a starch ingredient as described above. A dry mix is combined with water to achieve a moisture content of from about 8% to about 15% (e.g., about 9% to about 12%) by weight of the composition. Composition moisture contents at the lower end of the range can produce food pieces with a lower density, while moisture at the higher end of the range can produce food pieces with a higher density.

A composition is typically made in a continuous fashion by feeding ingredients into an extruder during an extrusion process. Extrusion conditions suitable for making a food piece provided herein generally include a barrel temperature of about 290 °F to about 340 °F (e.g., from about 300 °F to about 330 °F). As used herein, the term “barrel temperature” refers to the maximum temperature of a heated barrel of an extruder.

A method provided herein includes forming extruded food pieces from a composition by extruding the composition through a die opening whereby the composition is directly expanded (puffed) upon exiting the die. A die opening can be any appropriate geometry, such as circular opening, a slit, or an irregular opening, and if multiple openings are included in an extruder die assembly, each opening need not have the same geometry.

In some embodiments, extruded food pieces can have average diameter of from about 8 mm to about 20 mm (e.g., from about 10 mm to about 15 mm). However, the size of a food piece can be adjusted for the desired use of the food piece or to provide a manufacturing advantage. For example, the size of a food piece can be adjusted to provide a desired size for eating as a stand-alone RTE breakfast cereal or snack, or for use as a component in a snack bar or snack mix. In another example, the size of a food piece can be adjusted to result in a desired drying time during manufacturing. Piece size can be adjusted using known methods, such as die size and/or die shape selection, rate of extrusion, and/or cutter speed. For example, cutter speed can be reduced to form elongated puffed pieces, such as pieces resembling churros or snack straws or sticks.

In some embodiments, a food piece can be dried to a moisture content of up to 4% (e.g., about 1% to 4%, or about 2% to 4%) to produce dried food pieces. Drying can be performed using any suitable method and equipment, such as a belt dryer.

In some embodiments, food pieces provided herein can be packaged and sold as a food product without any other components. Such packaged food pieces can be intended to be eaten as a food product alone or in combination with other food products. For example, food pieces can be packaged and sold as a stand-alone snack, alone or as part of a RTE breakfast cereal. In some embodiments, a food piece can be adhered with one or more edible components, such as another food piece, nut pieces, fresh or dried fruit pieces, seeds, coconut, grain, and the like, to form an aggregate cluster or bar. A food piece and one or more edible components can be adhered to each other using any appropriate method and ingredients (e.g., edible binders and the like). For example, a cluster can be produced using a combination of a food piece and rolled oats adhered using a honey-based binder or slurry. Clusters can be provided as a food product alone or as part of a food product, such as a snack mix, ready to eat cereal, or oatmeal mix.

It is to be understood that food pieces provided herein can be used for either sweet or savory applications in food. Food pieces disclosed herein can provide a benefit of being a high protein stand-alone food product or provide added protein in combination with other components in food products while also providing an improved texture and flavor over other known high protein pieces.

The implementations described above and other implementations are within the scope of the following claims. One skilled in the art will appreciate that the present disclosure can be practiced with embodiments other than those disclosed. The disclosed embodiments are presented for purposes of illustration and not limitation.

1. A ready-to-eat (RTE) puffed food piece having a bulk density of 100 to 200 g per 100 in³, the puffed food piece having a total fiber content of at least 32% to about 50% by dry weight of the puffed food piece, an insoluble fiber content of at least 25% to about 40% by dry weight of the puffed food piece, and a soluble fiber content of about 5% to about 15% by dry weight of the puffed food piece, the insoluble fiber content and the soluble fiber content being at a ratio of at least 2:1, the puffed food piece consisting essentially of:
a. an amount of bran sufficient to provide insoluble fiber in an amount of at least 20% by dry weight of the puffed food piece;
b. psyllium husk in an amount of about 5% to about 15% by dry weight of the puffed food piece;
c. a starch ingredient having a starch content of at least 50% by dry weight of the starch ingredient, wherein the starch ingredient, the psyllium husk, and the bran contribute a total starch content in an amount of about 30% to about 65% by dry weight of the puffed food piece; and
d. a moisture content of up to 4% by weight of the puffed food piece.

2. The RTE puffed food piece of claim 1, wherein the total fiber content is from about 38% to about 45% by dry weight of the puffed food piece.

3. The RTE puffed food piece of claim 1, wherein the insoluble fiber content is from about 25% to about 35% by dry weight of the puffed food piece.

4. The RTE puffed food piece of claim 1, wherein the insoluble fiber content and the soluble fiber content are at a ratio of at least 3:1.

5. The RTE puffed food piece of claim 1, wherein the bran is included in an amount sufficient to provide at least 90% by dry weight of the insoluble fiber content.

6. The RTE puffed food piece of claim 1, wherein the psyllium husk is included in an amount sufficient to provide at least 90% by dry weight of the soluble fiber content.

7. The RTE puffed food piece of claim 1, wherein the bran comprises corn bran or wheat bran.

8. The RTE puffed food piece of claim 7, wherein the bran comprises corn bran and wheat bran at a ratio of 1:1 to 1:3 corn bran to wheat bran.

9. The RTE puffed food piece of claim 1, wherein the starch ingredient comprises a grain flour or meal that contributes at least 50% by dry weight of the total starch content.

10. The RTE puffed food piece of claim 1, wherein the density is from about 120 to about 180 g per 100 in³.

11. The RTE puffed food piece of claim wherein other ingredients total less than 5% by dry weight of the puffed food piece.

12. The RTE puffed food piece of claim 1, wherein the bulk density is about 120 to about 180 g per 100 in³, the total fiber content is at least 38% to about 45% by dry weight of the puffed food piece, the insoluble fiber content is at least 25% to about 35% by dry weight of the puffed food piece, and the soluble fiber content is about 7% to about 10% by dry weight of the puffed food piece, the insoluble fiber content and the soluble fiber content being at a ratio of at least 3:1, the puffed food piece consisting of:
a. the bran in an amount sufficient to provide at least 90% by dry weight of the insoluble fiber content;
b. the psyllium husk in an amount sufficient to provide at least 90% by dry weight of the soluble fiber content;
c. the starch ingredient comprising a grain flour or meal that contributes at least 50% by dry weight of the total starch content; and
d. other ingredients in an amount that totals less than 5% by dry weight of the puffed food piece.

13. A RTE food product, comprising the RTE puffed food piece of claim 1 and a coating on at least a portion of a surface of the puffed food piece.

14. A RTE food product, comprising an agglomeration that includes a binder and a plurality of the RTE puffed food pieces of claim 1, the binder binding the plurality together to form the agglomeration.

15. A RTE food product, comprising an agglomeration that includes a binder, the RTE puffed food piece of claim 1, and a second edible piece, the binder binding the puffed food piece and the second edible piece together to form the agglomeration.

16. A method of making a RTE puffed food piece, comprising:
a. providing a dry mix having a total fiber content of at least 35% to about 50% by dry weight of the dry mix, an insoluble fiber content of at least 25% to about 40% by dry weight of the dry mix, and a soluble fiber content of about 5% to about 15% by dry weight of the dry mix, the insoluble fiber content and the soluble fiber content being at a ratio of at least 2:1, the dry mix consisting essentially of:
i. an amount of bran sufficient to provide insoluble fiber in an amount of at least 20% by dry weight of the dry mix;
ii. psyllium husk in an amount of about 5% to 15% by dry weight of the dry mix; and
iii. a starch ingredient having a starch content of at least 50% by dry weight of the starch ingredient, wherein the starch ingredient, the psyllium husk, and the bran contribute a total starch content in an amount of about 30% to about 65% by dry weight of the dry mix;
b. under extrusion conditions, combining the dry mix with water to form a dough having a moisture content of about 8% to about 15% by weight of the dough;
c. extruding the dough through a die opening and directly expanding the dough to form the RTE puffed food piece; and
d. drying the RTE puffed food piece to a moisture content of 4% or less.

17. A ready-to-eat (RTE) puffed food piece having a bulk density of 100 to g per 100 in³, the puffed food piece having a total fiber content of at least 32% to about 50% by dry weight of the puffed food piece, an insoluble fiber content of at least 25% to about 40% by dry weight of the puffed food piece, and a soluble fiber content of about 5% to about 15% by dry weight of the puffed food piece, the insoluble fiber content and the soluble fiber content being at a ratio of at least 2:1, the puffed food piece consisting essentially of:
a. an amount of bran sufficient to provide insoluble fiber in an amount of at least 8% by dry weight of the puffed food piece;
b. an amount of a second insoluble fiber source sufficient to provide an amount of insoluble fiber in an amount of at least 8% by dry weight of the puffed food piece, where the bran and the second insoluble fiber source provide a total insoluble fiber content of at least 20% by dry weight of the puffed food piece, the second insoluble fiber source having an insoluble fiber content of at least 75% by weight and selected from oat hull fiber, sugar cane fiber, rice fiber, bamboo fiber, refined cellulose, or a combination thereof;
c. psyllium husk in an amount of about 5% to about 15% by dry weight of the puffed food piece;
d. a starch ingredient having a starch content of at least 50% by dry weight of the starch ingredient, wherein the starch ingredient, the psyllium husk, the bran, and the second insoluble fiber source contribute a total starch content in an amount of about 30% to about 65% by dry weight of the puffed food piece; and
e. a moisture content of up to 4% by weight of the puffed food piece.

18. The RTE puffed food piece of claim 17, wherein the ratio of insoluble fiber from the bran and insoluble fiber from the second insoluble fiber source is from about 2:1 to about 1:2.

19. The RTE puffed food piece of claim 17, wherein the second insoluble fiber source is selected from oat hull fiber, sugar cane fiber, rice fiber, or a combination thereof.

20. A method of making a RTE puffed food piece, comprising:
a. providing a dry mix having a total fiber content of at least 35% to about 50% by dry weight of the dry mix, an insoluble fiber content of at least 25% to about 40% by dry weight of the dry mix, and a soluble fiber content of about 5% to about 15% by dry weight of the dry mix, the insoluble fiber content and the soluble fiber content being at a ratio of at least 2:1, the dry mix consisting essentially of:
i. an amount of bran sufficient to provide insoluble fiber in an amount of at least 8% by dry weight of the dry mix;
ii. an amount of a second insoluble fiber source sufficient to provide an amount of insoluble fiber in an amount of at least 8% by dry weight of the dry mix, where the bran and the second insoluble fiber source provide a total insoluble fiber content of at least 20% by dry weight of the dry mix, the second insoluble fiber source having an insoluble fiber content of at least 75% by weight and selected from oat hull fiber, sugar cane fiber, rice fiber, bamboo fiber, refined cellulose, or a combination thereof;
iii. psyllium husk in an amount of about 5% to 15% by dry weight of the dry mix; and
iv. a starch ingredient having a starch content of at least 50% by dry weight of the starch ingredient, wherein the starch ingredient, the psyllium husk, the bran, and the second insoluble fiber source contribute a total starch content in an amount of about 30% to about 65% by dry weight of the dry mix;
b. under extrusion conditions, combining the dry mix with water to form a dough having a moisture content of about 8% to about 15% by weight of the dough;
c. extruding the dough through a die opening and directly expanding the dough to form the RTE puffed food piece; and
d. drying the RTE puffed food piece to a moisture content of 4% or less.
